(19) United States
(12) Patent Application Publication
(10) Pub. No.: US 2006/0078702 A1
(43) Pub. Date: Apr. 13, 2006

(54) Self-adhesive joint and adhesion method

(75) Inventor: Philippe Velard, Villebois (FR)

Correspondence Address: OLIFF & BERRIDGE, PLC, P.O. BOX 19928, ALEXANDRIA, VA, 22320, US

(73) Assignee: SAINT GOBAIN PERFORMANCE PLASTICS GESSIL, Saint Quentin Fallavier (FR)

(21) Appl. No.: 11/227,121

(22) Filed: Sep. 16, 2005

(30) Foreign Application Priority Data
Sep. 16, 2004 (FR) 04.09851

(51) Int. Cl. B32B 33/00

(52) U.S. Cl. 428/40.1

(57) ABSTRACT

The present invention relates to a self-adhesive sealant for sealing a silicone element onto an application site, comprising: a support; a layer of adhesive on that side of the support which is intended to come into contact with the application site; and a layer of an ultraviolet-curable silicone bonding agent on that side of the support which is intended to come into contact with the silicone element. It also relates to a silicone element provided with such a sealant and to a method of applying adhesive to a silicone element using this sealant.

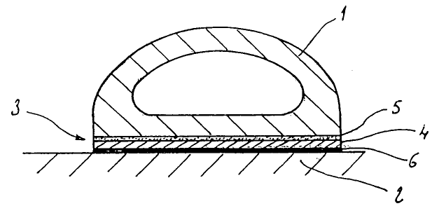

The present invention relates to a self-adhesive sealant for sealing a silicone element onto an application site, it also relates to a method of applying adhesive using such a sealant.

Silicone materials are being increasingly used in numerous industrial sectors, such as in motor vehicle manufacture, in buildings and in hard goods, for their longevity, their chemical and physiological inertness, and their resistance to extreme temperatures and to atmospheric agents. However, precisely because of such remarkable properties, these materials are often difficult to seal onto other materials with which they are not compatible.

A sealant for sealing a first material onto a second material, of different chemical nature and incompatible with the first, generally consists of a support that includes a layer of adhesive on each of its faces, each layer of adhesive being compatible with the material with which it is intended to come into contact. If one of the materials is a silicone material, it is often necessary to add an additional compound to the adhesive so as to make it compatible with the silicone material. These additional compounds are often present in a solvent phase. The process for manufacturing these sealants is thus lengthy, complicated, hazardous and expensive. This is because the use of a solvent involves a necessary drying period in order to remove the solvent, this period possibly being relatively long. Thus, the product cannot be easily handled and cannot be used as it leaves the manufacturing line.

Document U.S. 2004/0007827 describes a sealant, which includes a support, for sealing a silicone element onto an application site, the said support including a layer of adhesive on each of its faces, an additional layer of bonding agent, for example a primer, being added between one of the layers of adhesive and the support.

Thus, the manufacture of the sealant disclosed in the above document is meticulous and lengthy.

The object of the present invention is to remedy these drawbacks by proposing a self-adhesive sealant for sealing a silicone element onto any application site, this sealant being simple to manufacture and comprising a minimum of components.

One subject of the present invention is a self-adhesive sealant for sealing a silicone element onto an application site, comprising:
a support;
a layer of adhesive on that side of the support which is intended to come into contact with the application site; and
a layer of an ultraviolet-curable silicone bonding agent on that side of the support which is intended to come into contact with the silicone element.

Another subject of the invention is a silicone element provided with a self-adhesive sealant as described above.

Another subject of the present invention is a method of applying adhesive to a silicone element, comprising the following steps:
a) a silicone element is taken;
b) the element is coated with a layer of ultraviolet-curable silicone bonding agent;
c) a support is applied to the layer of bonding agent;
d) a layer of adhesive is applied to the support, using pressure; and
e) the product obtained at d) is exposed to ultraviolet radiation for a few seconds.

Such a method of applying adhesive is particularly simple and rapid, and does not require the use of a solvent. Thus, a lengthy, meticulous and hazardous step is avoided.

Moreover, thanks to the specific bonding agent used for the sealant of the present invention, cohesive adhesion is obtained. The sealant therefore retains its integrity over the period of its use, and also its excellent mechanical properties. The sealant is durable and runs no risk of degrading over time. It is particularly effective.

Thanks in particular to the ultraviolet curing of step e), the silicone element provided with the sealant according to the invention can be handled directly as it leaves the manufacturing line, and its manufacturing time is considerably reduced. The silicone element provided with the sealant according to the invention can thus be bonded directly onto the application site, by simply placing it thereon, without any other mechanical retaining means.

The silicone element that it is desired to seal onto or adhere to the application site may be of any form. This may be an extruded profile intended to serve as a seal, for example for a car sunroof, or else for a window in a building.

The application site may be made of any material, such as for example a metal, wood, glass, plastic or rubber.

The support may be chosen from any material exhibiting a barrier effect with respect to the layer of adhesive and to the layer of bonding agent. In particular, the support may be a nonwoven, a polymer foam or a polymer-based film. In a preferred embodiment of the invention, the support for the self-adhesive sealant according to the invention is in the form of a film based on a polymer chosen from polypropylene, polyethylene, polyester, polyvinyl chloride and blends thereof. More preferably, this polymer is chosen from polypropylene, polyester and blends thereof. Advantageously, the support is transparent.

Within the context of the present application, a part is said to be “transparent” if it lets the ultraviolet radiation through it.

Such supports are known and commercially available.

Preferably, the adhesive of the layer on that side of the support which is intended to come into contact with the application site is chosen from polyacrylic adhesives, polyurethane adhesives, silicone adhesives, rubber adhesives and blends thereof. Advantageously, this adhesive is transparent.

Such adhesives are known and commercially available.

The sealant according to the invention includes a layer of ultraviolet (UV)-curable silicone bonding agent. This layer of bonding agent is present on that side of the support which is intended to come into contact with the silicone element. This layer of bonding agent forms a high-strength rubbery material after exposure to the UV. Preferably, this bonding agent is based on a modified UV-curable acetic silicone. A bonding agent that is particularly suitable for the sealant according to the invention is commercially available under the brand name “Loctite® 5083” from Loctite France.

In a preferred embodiment of the invention, both the support and the adhesive are transparent. The UV curing step can therefore be carried out in an optimum manner.

Preferably, the silicone element provided with the self-adhesive sealant according to the invention has a peel strength between the silicone element and the support of 30 N/25 mm or higher. This value corresponds to cohesive failure of the silicone bonding agent.

In the present application, the peel strength is measured according to the following method:
the sealant according to the invention is applied, using the method of applying adhesive according to the invention, to a silicone element specimen having the following dimensions: length 150 mm; width 25 mm, i.e. an area of 37.5 cm².

One end of the specimen is kept fixed. At the other end, the force needed to separate the silicone element from the sealant at an angle of 90° is measured according to the NFT 46008 standard.

The method of applying adhesive according to the invention will now be described.

In a first step—step a)—a silicone element is taken. Such an element may be of any form. In general, it is in the form of an extruded profile.

In a second step—step b)—the silicone element is coated with a layer of UV-curable silicone bonding agent as described above. Preferably, the coating has a thickness ranging from 1 micron to 1 mm.

In a third step—step c)—a support as described above is applied to the layer of bonding agent and then, in a fourth step—step d)—a layer of adhesive as described above is applied to the support.

In a preferred way of implementing the invention, a single-sided adhesive is used that comprises the support and the layer of adhesive already present on the support. Thus, the third and fourth steps, i.e. step c) and step d), now form only a single step. The manufacturing process is thus simplified.

Examples of single-sided adhesives suitable for the present invention are commercially available under the brand names “9850” from Nitto, “2670” from GPI, “K125” from Scapatapes, and “PL2221” from Mactac.

The single-sided adhesive or the layer of adhesive alone is applied with a predefined pressure, depending on the geometry of the silicone element.

In a final step, the product obtained in the previous step is exposed to UV radiation for a few seconds, preferably for 1 to 30 seconds, depending on the exposure conditions. Preferably, in step e), UV radiation of 30 mW/cm² is applied for about 20 seconds.

The curing step may be prolonged at room temperature for 48 h, thanks to the moisture in the air. However, the product, namely the silicone element provided with the self-adhesive sealant, can be handled immediately it leaves the adhesive-application line.

In a preferred way of implementing the method according to the invention, the layer of adhesive is covered with a protective film before or after step e). Preferably, this protective film is transparent, in particular if it is placed over the layer of adhesive before the curing step e). In one embodiment of the invention, this protective film is already present on the single-sided adhesive, on the opposite side from the support. This protective film gives preference to the adhesion of the layer of adhesive to its support, while being unwound from the roll of single-sided adhesive.

The protective film thus placed on the self-adhesive sealant according to the invention prevents soiling while the self-adhesive sealant is being handled, packaged and transported. This protective film must be removed before the sealant is used.

Thus, in one embodiment of the invention, the silicone element provided with the self-adhesive sealant includes a protective film that covers the layer of adhesive.

The present invention will now be described in greater detail, in particular with the aid of the single FIGURE that shows a silicone element sealed onto an application site by the self-adhesive sealant according to the invention.

This FIGURE shows a silicone element 1 which, in this example, is a seal for a motor vehicle sunroof. This element 1 is sealed onto an application site 2 which, in this example, is the said sunroof. The self-adhesive sealant 3 includes a support 4, for example a polyester support. The sealant 3 also includes, between the silicone element 1 and the support 4, a layer 5 of UV-curable silicone bonding agent and, between the application site 2 and the support 4, a layer 6 of adhesive, for example an acrylic adhesive.

Such a sealant is particularly effective from 72 h after it leaves the adhesive-application line. It is resistant to temperature changes, heat and frost.

The present invention will now be illustrated using the example below.

### EXAMPLE 1

Four identical silicone elements (Elements 1 to 4) were collected. A layer of modified UV-curable acetic silicone bonding agent, sold under the brand name “Loctite® 5083” from Loctite France, was applied to each of these elements. A different single-sided adhesive was then applied to each element. The single-sided adhesives used (Adhesives 1 to 4) were the following:
Adhesive 1: uniaxially oriented polypropylene support and polyacrylic layer of adhesive, sold under the brand name “9850” by Nitto;
Adhesive 2: polyester support and polyacrylic layer of adhesive, sold under the brand name “2670” by GPI;
Adhesive 3: polyester support with silicone protective film and polyacrylic layer of adhesive, sold under the brand name “K125” by Scapatapes; and
Adhesive 4: polyester support and polyacrylic layer of adhesive, sold under the brand name “PL2221” by Mactac.

Each of the products obtained was then subjected to the peel test described in the present application.

The peel values measured are given in the table below:

| Element | Peel value (N/25 mm) |
|---|---|
| Element 1 (Adhesive 1) | 35 |
| Element 2 (Adhesive 2) | 42 |
| Element 3 (Adhesive 3) | >70 |
| Element 4 (Adhesive 4) | >70 |

In each case, the layer of bonding agent fails cohesively.

1. Self-adhesive sealant for sealing a silicone element onto an application site, comprising:
a support;
a layer of adhesive on that side of the support which is intended to come into contact with the application site; and
a layer of an ultraviolet-curable silicone bonding agent on that side of the support which is intended to come into contact with the silicone element.

2. Sealant according to claim 1, characterized in that the support is chosen from any material exhibiting a barrier effect with respect to the layer of adhesive and to the layer of bonding agent.

3. Sealant according to claim 2, characterized in that the support is a nonwoven, a polymer foam or a polymer-based film.

4. Sealant according to the claim 3, characterized in that the support is in the form of a film based on a polymer chosen from polypropylene, polyethylene, polyester, polyvinyl chloride and blends thereof.

5. Sealant according to claim 4, characterized in that the polymer is chosen from polypropylene, polyester and blends thereof.

6. Sealant according to claim 1, characterized in that the adhesive of the layer on that side of the support which is intended to come into contact with the application site is chosen from polyacrylic adhesives, polyurethane adhesives, silicone adhesives, rubber adhesives and blends thereof.

7. Sealant according to claim 1, characterized in that the bonding agent is based on a modified UV-curable acetic silicone.

8. Sealant according to claim 1, characterized in that both the support and the adhesive are transparent.

9. Silicone element provided with a self-adhesive sealant according to claim 1.

10. Silicone element according to claim 9, characterized in that it includes a protective film that covers the layer of adhesive.

11. Element according to claim 9, characterized in that it has a peel strength between the silicone element and the support of 30 N/25 mm or higher.

12. Method of applying adhesive to a silicone element, comprising the following steps:
a) a silicone element is taken;
b) the element is coated with a layer of ultraviolet-curable silicone bonding agent;
c) a support is applied to the layer of bonding agent;
d) a layer of adhesive is applied to the support, using pressure; and
e) the product obtained at d) is exposed to ultraviolet radiation for a few seconds, preferably for 1 to 30 seconds.

13. Method according to claim 12, characterized in that UV radiation of 30 mW/cm² is applied in step e) for about 20 seconds.

14. Method according to claim 12, characterized in that a single-sided adhesive is used that comprises the support and the layer of adhesive already present on the support, step c) and step d) thus now forming only a single step.

15. Method according to claim 12, characterized in that the layer of adhesive is covered with a protective film before or after step e).
